(19) United States
(12) Patent Application Publication
(10) Pub. No.: US 2007/0040517 A1
(43) Pub. Date: Feb. 22, 2007

(54) CONTROL CIRCUIT AND SYSTEM FOR FLUORESCENT LAMP

(76) Inventor: Chung-Che Yu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,810

(22) Filed: Jan. 12, 2006

(30) Foreign Application Priority Data
Aug. 22, 2005 (TW) 94128563

(51) Int. Cl. H05B 41/36

(52) U.S. Cl. 315/291

(57) ABSTRACT

A control circuit for controlling a fluorescent lamp is provided. The control circuit for a fluorescent lamp according to the present invention employs a pulse generator for generating a pulse signal, having a frequency varying within a predetermined range, to control the inverter to drive the fluorescent lamp, and thus reducing visual noises caused by a control circuit for a fluorescent lamp in the conventional arts.

### CROSS-REFERENCE TO RELATED APPLICATION

This application claims the priority benefit of Taiwan application serial no. 94128563, filed on Aug. 22, 2005. All disclosure of the Taiwan application is incorporated herein by reference.

### BACKGROUND OF THE INVENTION

1. Field of the Invention

The present invention relates to a control circuit for a fluorescent lamp, and particularly to a control circuit for a fluorescent lamp with low visual noise.

1. Description of Related Art

Liquid crystal displays (LCDs) are now widely used for substituting conventional cathode ray tube (CRT) displays. Accompanying with improvements of semiconductor technologies, LCDs exhibit more advantages, such as lower power consumption, slimmer body, lighter weight, higher resolution, better color saturation, and longer operating lifetime, such that LCDs become popular in many electronic applications including digital camera, laptop, desktop, cellular phone, personal digital assistant (PDA), mobile television, global position system (GPS), palm gamer, translation device, electronic watch, etc.

An LCD usually uses a cold cathode fluorescent lamp (CCFL) as its backlight source. For stable operation, the CCFL needs a sine-wave power with frequency ranging from 30 KHz to 80 KHz and without any composition of direct current (DC). The voltage of the CCFL for stable operation is almost a constant, and the brigtness of the CCFL is determined by the current flowing through the CCFL.

In practical application, a fixed operating frequency is generally adopted for the fluorescent lamp because the noise within the operating frequency of the fluorescent lamp can be better controlled. However, large-sized LCD panels demand large amount of fluorescent lamps, such that the high frequency noise generated thereby is increased greatly.

In order to prevent from the beat interferences occurred between the operating frequency of the fluorescent lamp and the vertical/horizontal scan signal of the display panel, an approach is to employ different control circuits having different operating frequencies or the phases to different fluorescent lamps. Therefore, the noise resulted from the operation of the fluorescent lamp can be reduced. However, the approach requires more control circuits and higher production cost.

The trend of LCDs development is towards larger size and lower price. However, under circumstances that the power consumption of the fluorescent lamp is getting lager and the requirement for the visual noise is getting stricter, the manufacture of the fluorescent lamps with lower visual noise and lower production cost becomes harder and harder.

### SUMMARY OF THE INVENTION

Accordingly, an object of the invention is to provide a control circuit for a fluorescent lamp. Through adjusting the operating frequency of the pulse signal, the visual noise of a fluorescent lamp is reduced.

Another object of the invention is to provide a system for controlling a fluorescent lamp. Through adjusting the operating frequency of the pulse signal according to a brightness adjusting signal, the visual noise of a fluorescent lamp is reduced.

For achieving the foregoing objects, the invention provides a control circuit for controlling a fluorescent lamp in a liquid crystal display with low visual noise. The control circuit includes a first pulse generator and a direct current/alternating current (DC/AC) inverter. The first pulse generator generates a first pulse signal and a first ramp wave signal with a time-varying frequency. The DC/AC inverter is coupled with the first pulse generator for driving the fluorescent lamp according to the first pulse wave signal and the first ramp wave signal.

According to an embodiment of the invention, the foregoing first pulse generator includes a digital counter, a current source, and a ramp wave generator. The current source provides a current to the ramp wave generator, and the operating frequencies of the ramp wave signal and the pulse signal generated by the ramp wave generator are determined according to the current. The digital counter dynamically adjusts the current flowing into the ramp wave generator, such that the ramp wave generator generates the ramp wave signal and the pulse signal with time-varying operating frequencies.

According to an embodiment of the invention, the frequency of the ramp wave signal generated by the foregoing first pulse generator varies either linearly or pseudorandomly.

According to an embodiment of the invention, the foregoing DC/AC inverter includes a first pulse width modulation (PWM) controller, a driving circuit, and a switch circuit. The first PWM controller outputs a first PWM signal according to a feedback signal and a first ramp wave signal. The driving circuit outputs at least one switch control signal according to the first PWM signal and the first pulse signal. The switch circuit outputs a voltage signal for driving the fluorescent lamp according to the least one switch control signal.

According to an embodiment of the invention, the foregoing switch circuit can be a half-bridge power switch or a push-pull power switch.

According to an embodiment of the invention, the foregoing DC/AC inverter further includes a detection circuit and a protection circuit. The detection circuit detects the conducting status of the fluorescent lamp and outputs a detection signal. The protection circuit receives the detection signal and outputs a protection signal according to the detection signal to stop the DC/AC inverter to outputting the voltage signal.

According to an embodiment of the invention, the foregoing detection circuit is a voltage detection circuit or a current detection circuit, for detecting a voltage or a current of the fluorescent lamp.

According to an embodiment of the invention, the foregoing DC/AC inverter further includes a resonance circuit. The resonance circuit filters the voltage signal into an AC signal, so as to drive the fluorescent lamp.

According to an embodiment of the invention, the control circuit for a fluorescent lamp further includes a second pulse generator and a second PWM controller. The second pulse generator generates a second ramp wave signal with a time-varying operating frequency. The second PWM controller outputs a second PWM signal to control the DC/AC inverter to output a voltage signal for driving the fluorescent lamp according to a brightness adjusting signal and the second ramp wave signal.

The present invention provides a system for driving a fluorescent lamp. The system includes a first pulse generator, a second pulse generator, and a DC/AC inverter. The first pulse generator generates a first pulse signal and a first ramp wave signal, wherein the operating frequencies of the first pulse signal and the first ramp wave signal are time-varying. The second pulse generator generates a second ramp wave signal, wherein the operating frequency of the second wave signal is time-varying. The DC/AC inverter outputs a voltage signal to drive the fluorescent lamp according to the first pulse signal, the first ramp wave signal, the second ramp wave signal, a feedback signal that indicates the conducting status of the fluorescent lamp, and a brightness adjusting signal.

According to an embodiment of the invention, the foregoing DC/AC inverter further includes a first PWM controller, a second PWM controller, a driving circuit, and a switch circuit. The first PWM controller outputs a first PWM signal according to a feedback signal and a first ramp wave signal. The second PWM controller outputs a second PWM signal according to a brightness adjusting signal and a second ramp wave signal. The driving circuit outputs at least one switch control signal according to the first PWM signal, the second PWM signal, and the first pulse signal. The switch circuit outputs a voltage signal for driving the fluorescent lamp according to the least one switch control signal.

The present invention changes the operating frequency of the pulse signal, such that it can adjust the brightness of the fluorescent lamp according to the conducting status of the fluorescent lamp and a brightness adjusting signal. Therefore, the visual noise produces by the fluorescent lamp can be reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 a schematic block diagram of a control circuit for a fluorescent lamp with low visual noise according to an embodiment of the invention.

FIG. 2 is a schematic diagram of a pulse signal generator of FIG. 1 according to an embodiment of the invention.

FIG. 3 is a timing sequence diagram corresponding to the pulse signals generated by the pulse signal generator in FIG. 2 according to an embodiment of the invention.

FIG. 4 is a schematic diagram of a control circuit for a fluorescent lamp with low visual noise according to an embodiment of the invention.

FIG. 5 is a timing sequence diagram corresponding to the pulse signals in FIG. 4 according to an embodiment of the invention.

FIG. 6 is a schematic diagram of a control circuit for a fluorescent lamp with low visual noise, which modulates lights according to the beam density, according to an embodiment of the invention.

FIG. 7 is a timing sequence diagram corresponding to the pulse signals in FIG. 6 according to an embodiment of the invention.

FIG. 8 is a schematic diagram of a push-pull DC/AC inverter according to an embodiment of the invention.

FIG. 9 is a schematic diagram of a DC/AC inverter with only one power switch according to an embodiment of the invention.

### DESCRIPTION OF THE EMBODIMENTS

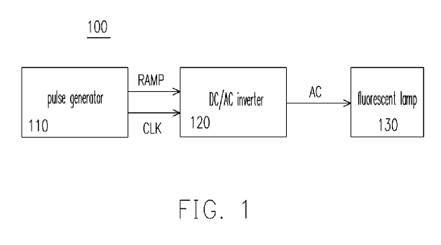

FIG. 1 is a schematic block diagram of a control circuit for a fluorescent lamp with low visual noise according to an embodiment of the invention. Referring to FIG. 1, the control circuit 100 is used to control fluorescent lamp(s) of a LCD.

As shown in FIG. 1, the control circuit 100 includes a pulse generator 110, a DC/AC inverter 120, and a fluorescent lamp 130. The pulse generator 110 is used to generate a triangle wave signal RAMP and a pulse signal CLK. The DC/AC inverter 120 is used to generate an AC signal for driving the fluorescent lamp 130 according to the triangle wave signal RAMP and the pulse signal CLK. In order to reduce the visual noise resulted from the DC/AC inverter 120, the operating frequencies of the triangle wave signal RAMP and the pulse signal CLK are controlled to vary within a predetermined range. Therefore, the beat interference generated between the triangle wave signal RAMP, the pulse signal CLK and the vertical and/or horizontal scan signals of the display device can be restrained. The beat interference is the so-called fan effect which forms visually-interfered ripples in the frames.

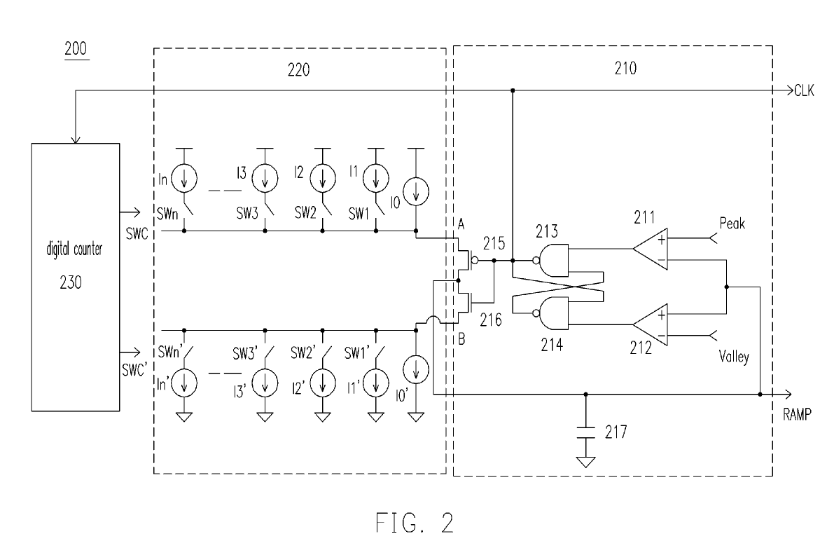

FIG. 2 is a schematic diagram of a pulse signal generator in FIG. 1 according to an embodiment of the invention. Referring to FIG. 2, the pulse generator 200 includes a triangle wave generator 210, whose operating frequency is controlled by a current, a controlled current source 220, and a digital counter 230. The triangle wave generator 210 includes two comparators 211 and 212, two NAND gates 213 and 214, a P-type metal oxide semiconductor (PMOS) switch 215, and an N-type metal oxide semiconductor (NMOS) switch 216. The controlled current source 220 includes a pair of chief current sources 10 and 10′, and multiple nonequivalent controlled current sources 11, I1′, I2, I2′, I3, I3′, . . . In, In′, wherein n is a natural number and n is greater than 3. The controlled current sources I1, I1′, I2, I2′, I3, I3′, . . . In, In′ are corresponding to current source switches SW1, SW1′, SW2, SW2′, SW3, SW3′, . . . , SWn, SWn′ respectively which control the timing that the controlled current sources I1, I1′, I2, I2′, I3, I3′, . . . In, In′ flow into a end A or a end B.

As shown in FIG. 2, the comparators 211 and 212 of the triangle wave generator 210 are used to compare the RAMP voltage with a peak voltage and a valley voltage. As RAMP>Peak, the NMOS switch 216 is switched on and the current at the end B discharges capacitor 217. As RAMP<Valley, the PMOS switch 215 is switched on and the current at the end A charges the capacitor 217.

In addition, a pulse signal CLK output from the triangle wave generator 210 is received by the digital counter 230. The digital counter 230 uses the pulse signal CLK as the clock signal of the digital counter 230 and generates different current switch control signals SWC and SWC′ according to different clock signals. Therefore, the controlled current source 220 is able to output different currents to the end A and end B according to the time variation. The triangle wave generator 210 generates a triangle wave signal RAMP and a pulse signal CLK with time-varying operating frequencies according to the current flowing through the end A and end B. We will describe the applications of the pulse generator 200 and the triangle wave generator 210 by the following embodiments of DC/AC inverter. However, in practice, the applications of the pulse generator 200 and the triangle wave generator 210 includes circuits that need pulse signal or the triangle wave.

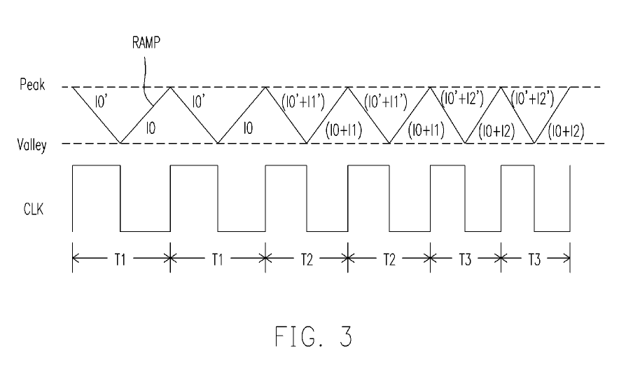

FIG. 3 is a timing sequence diagram corresponding to the pulse signals produced by the pulse signal generator in FIG. 2 according to the embodiment of the invention. Referring to FIG. 3, in the present embodiment, I1<I2<I3<. . . <In, and I1′<I2′<I3′<. . . <In′, therefore, T1>T2>T3>. . . >Tn. The digital counter 230 takes each two clock time as the unit to switch on the switches from SW1′, SW1, SW2′, SW2, . . . , to SWn′, SWn in sequence, and then switch on the switches from SWn-1′, SWn-1, . . . , back to SW1′, SW1 in sequence. The operating frequencies of the triangle wave signals RAMP and the pulse signal CLK are hereby repetitively alternated.

Moreover, the embodiment can use a programmable digital counter 230 to arbitrarily change the switching sequence of the current source switches SW1′, SW1, SW2′, SW2, SW3, SW3′, . . . , SWn′, SWn, so as to generate currents with arbitrarily alternated frequencies such as pseudorandom change.

In order to cooperate with the DC/AC inverter 120, in the present embodiment, the frequency changing cycle is set to be the clock time of every two pulse signal CLK. Of course, it can also be set by other arbitrary units such as only one clock unit of the pulse signal CLK. Herein, the waveform of the triangle wave signal RAMP may be changed through setting different current ratios, for example, as In<<In′, n=0,1,2,3, . . . , n., the waveform becomes a toothed wave.

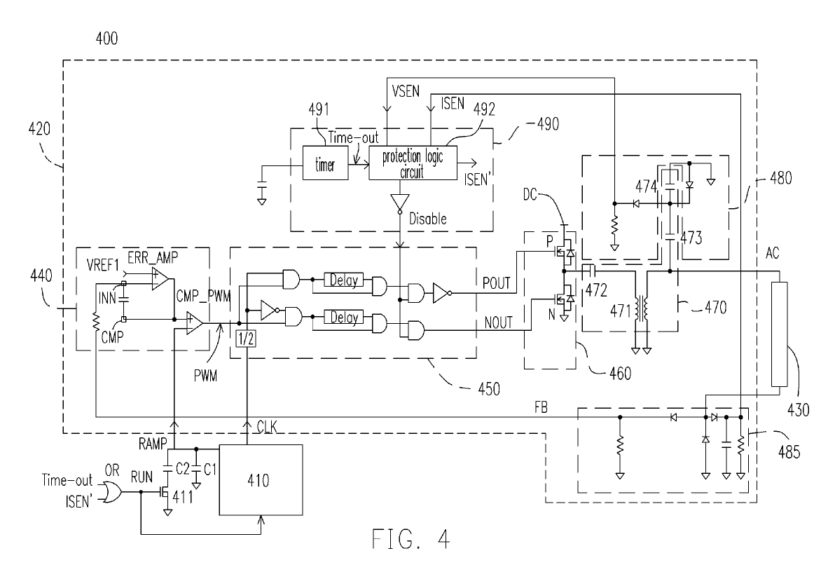

FIG. 4 is a schematic diagram of a control circuit 400 for a fluorescent lamp with low visual noise according to an embodiment of the invention. Referring to FIG. 4, the embodiment includes a pulse generator 210 as shown in FIG. 2, wherein the foregoing capacitor 217 are replaced by two different capacitors C1 and C2 as well as some other circuits. It further includes a half-bridge DC/AC inverter 420 and a fluorescent lamp 430.

The half-bridge DC/AC inverter 420 includes a direct current source DC, a PWM controller 440, a digital driving circuit 450, a set of half-bridge power switches 460, a resonance circuit 470, a voltage detection circuit 480, a current detection circuit 485, and a protection circuit 490.

In general, after the fluorescent lamp 430 is activated, the protection circuit 490 outputs a lamp conducted indicating signal ISEN′ corresponding to a lamp conducted condition indicating signal ISEN detected by the current detection circuit 485 outputs. The logic gate OR also outputs a “run” signal to the parallelly-connected capacitors Cl and C2 correspondingly to make the half-bridge DC/AC inverter 420 operate under a frequency lower than that before the fluorescent lamp 430 is activated. The current detection circuit 485 further sends a lamp current indicating signal FB to the PWM controller 440. Then, the PWM controller 440 compares the lamp current indicating signal FB with a first reference voltage VREF1 based on the negative feedback principle, and generates an output signal CMP. The comparator CMP-PWM compares the output signal CMP with the triangle wave signal RAMP generated by the pulse generator 410 and thereby obtains a PWM signal. According to the negative feedback principle, the duty cycle of the PWM signal increases as FB<VREF1, and decreases as FB>VREF1, so as to stabilize the operating current of the fluorescent lamp 430.

The PWM signal is then input into a digital driving circuit 450. The digital driving circuit 450 incorporates the PWM signal with the pulse signal CLK generated by the pulse generator 410 to generate power switch driving signals POUT and NOUT, which are used to drive the semiconductor switches P and N of the half-bridge power switch 460, respectively. The semiconductor switches P and N are conducted alternately in order to transform the DC power into a pulse signal, and then the pulse signal is input into the resonance circuit 470.

The inductance 471 and the capacitors 472, 473, and 474 in the transformer 471 of the resonance circuit 470 construct a filtering circuit which filters the pulse signal input from the semiconductor switches P and N into an AC signal, and then the AC signal is sent into the fluorescent lamp 430.

The protection circuit 490 receives a lamp voltage signal VSEN detected by the voltage detection circuit 480 and the lamp conducted condition indicating signal ISEN detected by the current detection circuit 485, and outputs the lamp conducted indicating signal ISEN′ to the capacitors C1 and C2 of the pulse generating unit 410. Typically the fluorescent lamp 430 can be activated with a voltage higher than normal operating voltage according to the characteristics of the fluorescent lamp, and the higher operating frequency helps improving the coupling efficiency of the transformer 471, so as to enhance the output voltage. When the fluorescent lamp 430 has already conducted according to the lamp conducted indicating signal ISEN′ or after a predetermined activation time of the fluorescent lamp 430 preset by the timer 491 of the protection circuit 490, the switch 411 is switched on and the capacitors C1 and C2 are connected in parallel to reduce the operating frequency.

After a certain time predetermined by a timer 491 of the protection circuit 490, a timing end signal Time_out is output to a protection logic circuit 492. In case the lamp voltage signal VSEN or the lamp conducted indicating signal ISEN indicates anything abnormal such as the spark-over phenomenon due to overloaded voltage, the short phenomenon of low voltage, or the open phenomenon due to disconnected lamp, such abnormal conditions can be detected by the protection circuit 490, and then a “disable” signal is output to disable the semiconductor power switches P and N according to the detection signal output from the protection circuit 490.

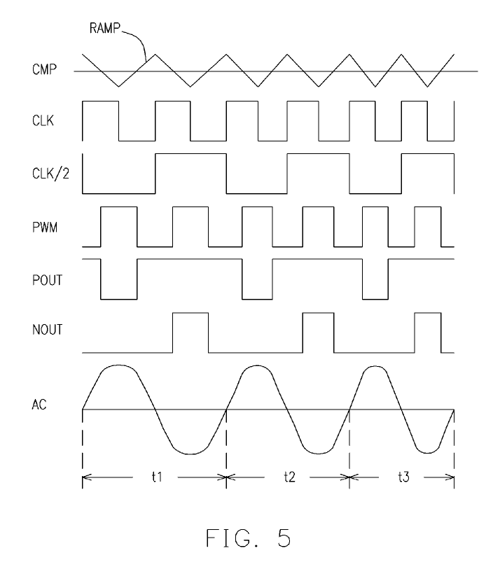

FIG. 5 is a timing sequence diagram corresponding to the pulse signals in FIG. 4 according to the embodiment of the invention. Referring to FIG. 5, because the amplitude of the triangle wave is fixed, the duty cycle of the PWM wave signal is also fixed, thus a stable AC signal is obtained and output into the fluorescent lamp 430, wherein the horizontal axis of FIG. 5 represents time, and the time intervals are t1>t2>t3.

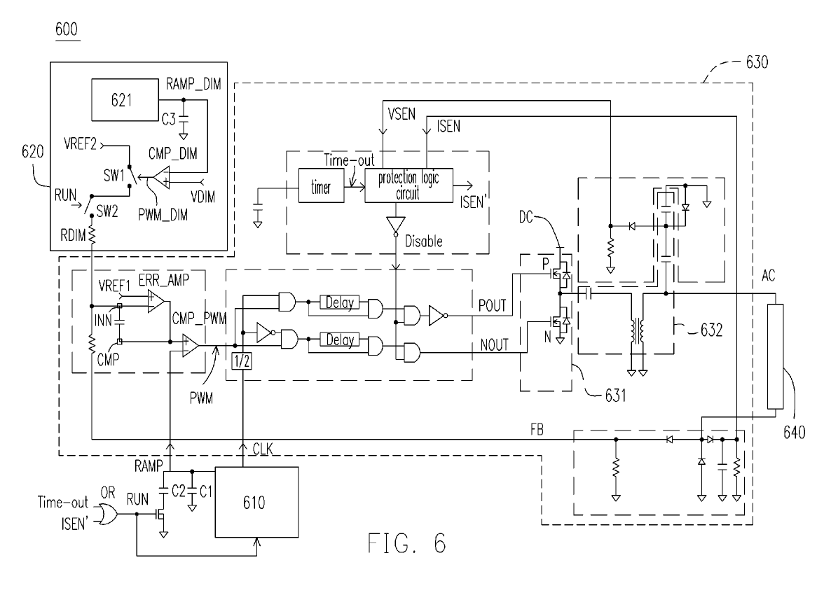

FIG. 6 is a schematic diagram of a control circuit 600 for a fluorescent lamp with low visual noise, which modulates light according to beam density, according to an embodiment of the invention. The embodiment discussed in FIG. 6, can be regarded as the control circuit 400 with low visual noise of FIG. 4 combined with a pulse generator 620 operating under an even lower operating frequency.

The control circuit 600 as shown in FIG. 6 includes a fluorescent lamp 640, a half-bridge DC/AC inverter 630, a first pulse generator 610 generating a pulse with an operating frequency of the fluorescent lamp, and a low frequency modulating pulse generator 620 for generating a pulse with a beam density modulating frequency. Practically, the operating frequency of the fluorescent lamp 640 is set as about 50 KHz, and the frequency for beam density modulating is set between 200 Hz and 2 KHz.

The low frequency modulating pulse generator 620 in FIG. 6 includes a second pulse generator 621 that generates a triangle wave RAMP_DIM with a time-varying operating frequency. After a comparator CMP_DIM compares the triangle wave signal RAMP_DIM with the input signal VDIM used for controlling brightness, a pulse width modulation signal PWM_DIM is generated. In actual use, the pulse width modulation signals PWM_DIM with different operating periods can be obtained by comparing the variable brightness adjusting signals VDIM with the triangle waves RAMP_DIM with fixed amplitude and time-varying operating frequency, such that the half-bridge DC/AC inverter 630 can generate output signals with different beam densities, so as to produce variable brightness.

In the present embodiment, the pulse width modulation signal PWM_DIM is used to control a switch SW1. When the pulse width modulation signal PWM_DIM outputs a logic “high” signal, the switch SW1 is switched on. When the pulse width modulation signal PWM_DIM outputs a logic “low” signal, the switch SW1 is switched off. Moreover, a switch SW2 is used to control when to start the modulating process. In the present embodiment, when the lamp conducted indicating signal ISEN′ indicates that the fluorescent lamp has been switched on or the timer 491 outputs a timing end signal Time_out, that means the predetermined time is up, the switch SW2 is switched on to start the modulating process. Once the switch SW2 is switched on, plus the condition that the switch SW1 is switched ON/OFF, a second reference voltage signal VREF2 or a floating signal is inputted to an inverted input end INN of an error amplifier ERR_AMP of the PWM controller of the half-bridge DC/AC inverter 630 through a resistance RDIM.

While the second reference voltage signal VREF2 is at the inverted input end INN of the error amplifier ERR_AMP and is greater than the first reference voltage VREF1 at the non-inverted input end, the output of the half-bridge DC/AC inverter 630 will be terminated. Otherwise, while the second reference voltage signal VREF2 is at the inverted input end INN of the error amplifier ERR_AMP and is less than the first reference voltage VREF1 at the non-inverted input end, the output of half-bridge DC/AC inverter 630 will be activated. While the switch SW2 is turned off, according to the negative feedback principle, the voltage at the inverted input end INN of the error amplifier ERR_AMP will be almost equal to the first reference voltage VREF1 of the non-inverted input end, and the half-bridge DC/AC inverter 630 will keep outputting accordingly.

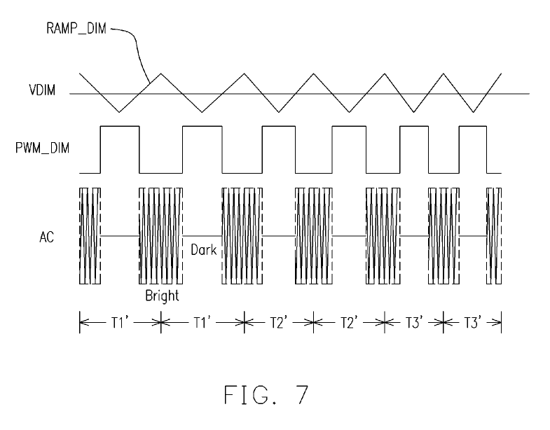

FIG. 7 is a timing sequence diagram of the pulse signals in FIG. 6 according to an embodiment of the invention. Referring to FIG. 7, in general, the fluorescent lamp 640 is driven by the bright portion of AC signal, and the bright portion of the AC signal is time-varying as shown in FIG. 5 and the time intervals are T1′>T2′>T3′.

In the present embodiment, the triangle wave signal RAMP_DIM also takes each two clock time as the unit to vary in sequence. Of course, it can also be taken by any other ways with different units, for example it can take one clock time as the unit to vary sequentially or pseudorandomly.

Furthermore, either both or one of the two triangle waves RAMP and RAMP_DIM in FIG. 6 can have time-varying operating frequencies. For example, only the operating frequency of the triangle waves RAMP is time-varying while the operating frequency of the triangle waves RAMP_DIM is fixed. In addition, the fluorescent lamp to be used could be one or more than one that connect with each other in series and/or in parallel.

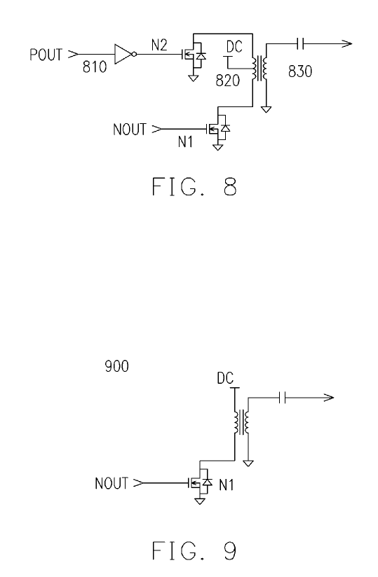

It is to be noted that the half-bridge AC/DC inverters 420 and 630 in FIG. 4 and FIG. 6 can have different driving structure. FIG. 8 is a schematic diagram of a push-pull DC/AC inverter according to an embodiment of the invention. Referring to FIG. 8, the power switch driving signal NOUT drives the N-type field effect transistors (FETs) N1, and the power switch driving signal POUT is inverted by an inverter 810 to drive the N-type field effect transistors (FETs) N2. By replacing with a center-tapped transformer, a push-pull inverter is formed.

FIG. 9 is a schematic diagram of a DC/AC inverter using only one power switch according to an embodiment of the invention. Referring to FIG. 9, only the power switch driving signal NOUT is used to drive the DC/AC inverter which has only one N-type MOSFET.

By implementing the pulse generator 200 in the embodiment of FIG. 2, the embodiments in FIGS. 8 and 9 can be designed to be DC/AC inverters having time-varying operating frequencies, so as to drive the fluorescent lamp.

In summary, the control circuit for a fluorescent lamp according to the present invention employs a pulse generator for generating a pulse signal with a frequency varying within a predetermined range, so as to control the inverter to drive the fluorescent lamp. Therefore, the visual noise produced by the control circuit of the fluorescent lamp is reduced.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A control circuit for a fluorescent lamp, adapted for controlling a fluorescent lamp, the control circuit comprising:
a first pulse generator, for generating a first pulse signal and a first ramp wave signal, wherein the operating frequencies of the first pulse signal and the first ramp wave signal are time-varying; and
a direct current/alternating current (DC/AC) inverter, for outputting a voltage signal to drive the fluorescent lamp according to the first ramp wave signal, the first pulse signal and a feedback signal that indicates the conducting status of the fluorescent lamp.

2. The control circuit according to claim 1, wherein the first pulse generator comprises:
a ramp wave generator, for generating the first pulse wave signal and the first ramp wave signal;
a current source, for providing a current for the ramp wave generator; and
a digital counter, for dynamically adjusting the current flowing from the current source to the ramp wave generator and thus allowing the ramp wave generator to generate the first pulse wave signal and the first ramp wave signal with time-varying frequencies.

3. The control circuit according to claim 1, wherein the DC/AC inverter comprises:
a first pulse width modulation (PWM) controller, adapted for outputting a first PWM signal according to the feedback signal and the first ramp wave signal;
a driving circuit, adapted for outputting at least one switch control signal according to the first PWM signal and the first pulse signal; and
a switch circuit, adapted for outputting the voltage signal for driving the fluorescent lamp according to the least one switch control signal.

4. The control circuit according to claim 3, wherein the switch circuit is a half-bridge power switch or a push-pull power switch.

5. The control circuit according to claim 3, wherein the DC/AC inverter further comprises:
a detection circuit, for detecting the conducting status of the fluorescent lamp and outputting a detection signal; and
a protection circuit, for receiving the detection signal and outputting a protection signal according to the detection signal to stop the DC/AC inverter to outputting the voltage signal.

6. The control circuit according to claim 5, wherein the detection circuit is a voltage detection circuit for detecting a voltage of the fluorescent lamp, a current detection circuit for detecting a current of the fluorescent lamp, or the combination thereof.

7. The control circuit according to claim 1, wherein the DC/AC inverter further comprises a resonance circuit, adapted for filtering the voltage signal into an AC signal to drive the fluorescent lamp.

8. The control circuit according to claim 1, wherein the amplitude of the first ramp wave is predetermined.

9. The control circuit according to claim 1, wherein the operating frequency of the voltage signal is time-varying.

10. The control circuit according to claim 1, further comprising:
a second pulse generator, for generating a second ramp wave signal, wherein the operating frequency of the second ramp wave signal is time-varying; and
a second PWM controller, for outputting a second PWM signal to control the DC/AC inverter to output a voltage signal for driving the fluorescent lamp, according to a brightness adjusting signal and the second ramp wave signal.

11. The control circuit according to claim 10, wherein the amplitude of the second ramp wave is predetermined.

12. The control circuit according to claim 10, wherein the duty cycle is determined by the brightness adjusting signal, and the duty cycle of the second ramp wave signal will be fixed whenever the brightness is fixed.

13. A control system for a fluorescent lamp, adapted for driving a fluorescent lamp, the control system comprising:
a first pulse generator, for generating a first pulse signal and a first ramp wave signal, wherein the operating frequencies of the first pulse signal and the first ramp wave signal are time-varying;
a second pulse generator, for generating a second ramp wave signal, wherein the operating frequency of the second wave signal is time-varying; and
a DC/AC inverter, for outputting a voltage signal to drive the fluorescent lamp according to the first pulse signal, the first ramp wave signal, the second ramp wave signal, a feedback signal that indicates the conducting status of the fluorescent lamp, and a brightness adjusting signal.

14. The control system according to claim 13, wherein the DC/AC inverter comprises:
a first PWM controller, adapted for outputting a first PWM signal according to the feedback signal and the first ramp wave signal;
a second PWM controller, for outputting a second PWM signal, according to the brightness adjusting signal and the second ramp wave signal;
a driving circuit, adapted for outputting at least one switch control signal according to the first PWM signal, the second PWM signal and the first pulse signal; and
a switch circuit, adapted for outputting a voltage signal to drive the fluorescent lamp according to the least one switch control signal.

15. The control system according to claim 14, wherein the switch circuit is a half-bridge power switch.

16. The control system according to claim 14, wherein the switch circuit is a push-pull power switch.

17. A ramp wave generator, for generating a ramp wave with time-varying frequencies, comprises:
a ramp wave unit, for generating the ramp wave signal;
a reference voltage generator for determining the amplitude of the ramp wave; and
a digital counter, for dynamically adjusting the current flowing from the current source to the ramp wave generator and thus allowing the ramp wave generator to generate the ramp wave signal with time-varying frequencies.

18. The ramp wave generator according to claim 17, wherein the ramp wave generator further generates a pulse signal.

19. The ramp wave generator according to claim 17, wherein the amplitude of the ramp wave is predetermined.

20. The ramp wave generator according to claim 17, wherein the operating frequency of ramp wave is within a predetermined range.

21. The ramp wave generator according to claim 17, wherein the digital counter take each n clock time as the unit to adjust the current and the n is even.

22. The ramp wave generator according to claim 21, wherein the n is 2.
